(19) United States
(12) Patent Application Publication
(10) Pub. No.: US 2002/0152822 A1
(43) Pub. Date: Oct. 24, 2002

(54) Ball screw having a cooling channel

(76) Inventor: Yung-Tsai Chuo, Taichung (TW)

Correspondence Address: BACON & THOMAS, PLLC, 4th Floor, 625 Slaters Lane, Alexandria, VA, 22314-1176, US

(21) Appl. No.: 09/839,364

(22) Filed: Apr. 23, 2001

(51) Int. Cl. F16H 27/02; F16H 29/02

(52) U.S. Cl. 74/89.13

(57) ABSTRACT

A ball screw having a cooling medium circulating channel inside the nut is to set two side covers, which set several inside trough channels, at two sides of the nut respectively and connecting trough channels inside the side covers with cooling channels inside the nut to form a cooling medium circulating channel such that a cooling medium is supplied from the inlet to the circulating channel to cool the nut and drained outward through the outlet after absorbing heat.

### BACKGROUND OF THE INVENTION

1. Field of the Invention

The present invention relates to a ball screw, especially the one setting a cooling medium circulating channel inside the nut.

2. Description of the Prior Art

The cooling method of the commonly seen ball screws is to trench an axial internal channel along the axial direction at the center of the screw, and usually is to bury a pipe inside the screw. One end of the pipe is connected to the inlet pipe at an aspect of the screw and the other end is connected to the outlet pipe at the opposite side of the screw. In this way, there is a one-way flow of coolant, such as oil, water, and cryogen, in part of the screw to bring out heat produced from rotation of the ball screw. The disadvantages of the design described above are:

1) Based on that length of common screws is much longer than length of nuts and a ball circulatory system is set inside the nut, when the ball screw works, time of contact between per unit area inside the nut and circulating balls is much longer than that between per unit area inside the screw and circulating balls. In this way, most heat of work centers on the nut such that the temperature of the nut is relatively higher than that of the screw. The commonly seen hollow ball screws described above only can cool directly the screw having relatively lower temperature and can't effectively cool the nut having higher temperature. The general effect of cooling is not obvious.

2) The hollow ball screw is used generally in machine tools having high feed rate. Because it is difficult to process an axial internal hole, it is hard to reach good concentricity. Therefore, a periodic eccentric force is produced and results in vibration of frame. The phenomenon has very detrimental influence on the finished precision of machine tools.

3) Because some reasons such as length and external diameter of the hollow screw, there are restraints on processing an axial internal hole and the finished cost is higher. Besides, the inlet and the outlet pipes are respectively set at two aspects of screw and the arrangement occupies larger space such that it is difficult to set up in narrow space. Therefore, inconvenience and restraints of application are formed.

4) Based on restriction of external diameter of the hollow screw, the coolant inside the screw is hard to form a circumfluence design but only a one-way flow passing the hollow screw. Therefore, time of heat exchange between coolant and the screw is very short, and efficiency of heat exchange is hard to arise efficiently.

The inventor of the present invention ruminated over the disadvantages resulted from the inside arrangement of the ball screw described above and earnestly deliberated the way of improvement and innovation. After studying hard for a long period, the inventor eventually succeeded in inventing the present invention, the ball screw having a cooling medium circulating channel inside the nut.

### SUMMARY OF THE INVENTION

The first purpose of the present invention is to provide a ball screw having a cooling channel which can cool the nut, which produces higher working temperature, directly and have better general cooling effect. Moreover, this ball screw is more suitable than the commonly seen hollow screw for high feed rate, heavy load, and heavy-load, high-speed machine tools with high processing precision.

The second purpose of the present invention is to provide a ball screw having a cooling channel, and the nut thereof have no phenomenon of eccentric vibration under high-speed working such that processing precision is arisen.

Another purpose of the present invention is to provide a ball screw having a cooling channel which can form a circumfluence circulating channel of a cooling medium inside the nut and effectively extend time for heat exchange between the cooling medium and the nut such that heat exchange efficiency of the cooling medium is effectively arisen and difficulty of processing is lower than that of the commonly seen hollow ball screw.

The other purpose of the present invention is to provide a ball screw having a cooling channel, and the outlet and the inlet therein can be chosen to directly set at the nut or the side covers at two sides of the nut such that space requiring for setting is much smaller than that of commonly seen hollow screw and can be arranged in narrow space. What described above is very convenient and suitable for each kind of machines (such as machine tools) using a ball screw as a transmission component.

The ball screw having a cooling channel, which can achieve the purposes of the invention described above, mainly sets side covers having inside trough channels at two sides of the nut, and forms a circumfluence circulating channel of a cooling medium by connecting the trough channels of side covers at two sides with several cooling channels inside the nut such that a cooling medium is supplied from the inlet and flows through the circulating channel to cool the nut and is drained outward through the outlet after absorbing heat.

The leak-proof spacers can be respectively set between the nut and its two side covers to prevent from leaking of a cooling medium. Simultaneously, the outlet and the inlet of the cooling medium can be connected to a cooling medium supply device respectively to form a complete cooling circulatory system, which means some known components such as a compressor, a condenser, a expansion valve, and so on, such that lower the working temperature of the cooling medium absorbing heat of the nut.

### BRIEF DESCRIPTION OF THE DRAWINGS

The drawings discloses an illustrative embodiment if the present invention which serves to exemplify the various advantages and objects hereof, and are as follows:

FIG. 1 is a axial cross-sectional view of the present invention, a ball screw having a cooling channel;

FIG. 2 is a lateral view of first actual example of the nut of the ball screw;

FIG. 3 is a front view of the nut in FIG. 2;

FIG. 4 is a lateral view of second actual example of the nut of the ball screw;

FIG. 5 is a front view of the nut in FIG. 4;

FIG. 6 is a lateral view of side covers at two sides of the nut of the ball screw; and

FIG. 7 is a front view of side covers in FIG. 6.

### DETAILED DESCRIPTION OF THE PREFERRED EMBODIMENT

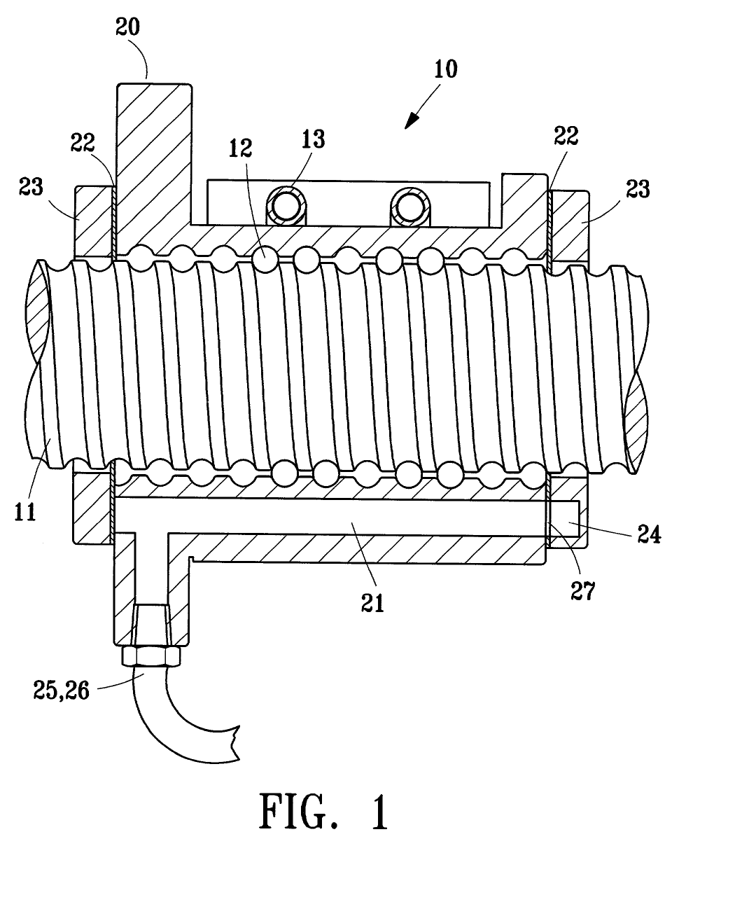

Referring to FIG. 1, the ball screw 10 provided from the present invention comprises a screw 11, that the type of the screw is know, several balls 12, a ball circulatory system 13 and a nut 20 having several cooling channels 21, which is the principle technological feature of the present invention. The balls 12 are set between the screw 11 and the nut 20, and have circulating motion by using the ball circulatory system. When the screw 11 rotates, the nut can be driven to shift linearly by the balls 12 such that the ball screw 10 can serves as the feed device of machines, such as machine tools.

The present invention mainly trenches several cooling channels 21, which pass through the nut 20, to make a cooling medium with set working temperature enter the interior of the nut 20 and proceed heat exchange with the nut 20 to bring away heat resulted from the circulating friction between the nut 20 and balls 20. The cooling medium indicates every substances, including liquid and gas, which has cooling effect.

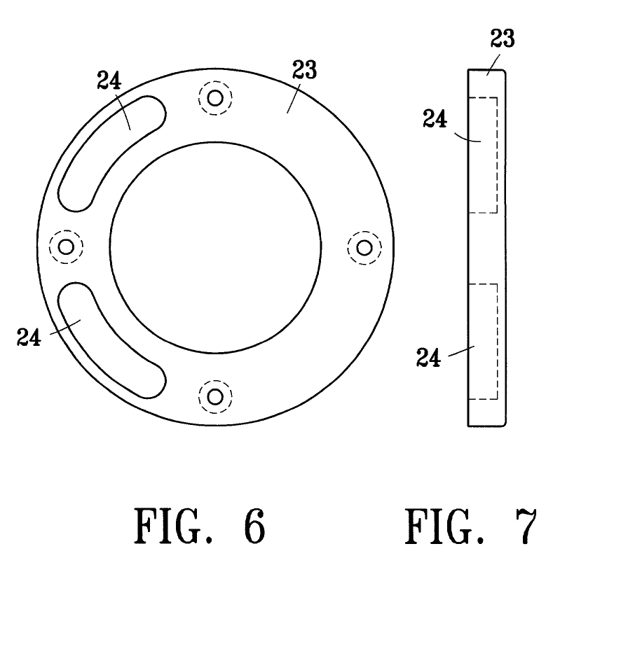

The two sides of the nut 20 respectively have a side cover 23 (as shown in FIGS. 6 and 7), which has at least one trough channel 24 inside. A circumfluence circulating channel of the cooling medium is formed by connecting the trough channel 24 of two side covers with several cooling channels inside the nut 20. The cooling medium is supplied from the inlet 25 to the circumfluence circulating channel to cool the nut and drained outward the nut 20 through the outlet 26 after absorbing heat.

A leak-proof spacer 22 can be set between the nut 20 and the side covers 23 of both sides to avoid an improper leak of the cooling medium. The number and the location of holes 27 of the leak-proof spacer 22 should be referred to the location of the trough channels 24 of the side covers 23 to prevent from influencing the free flow of the cooling medium in the circumfluence circulating channel.

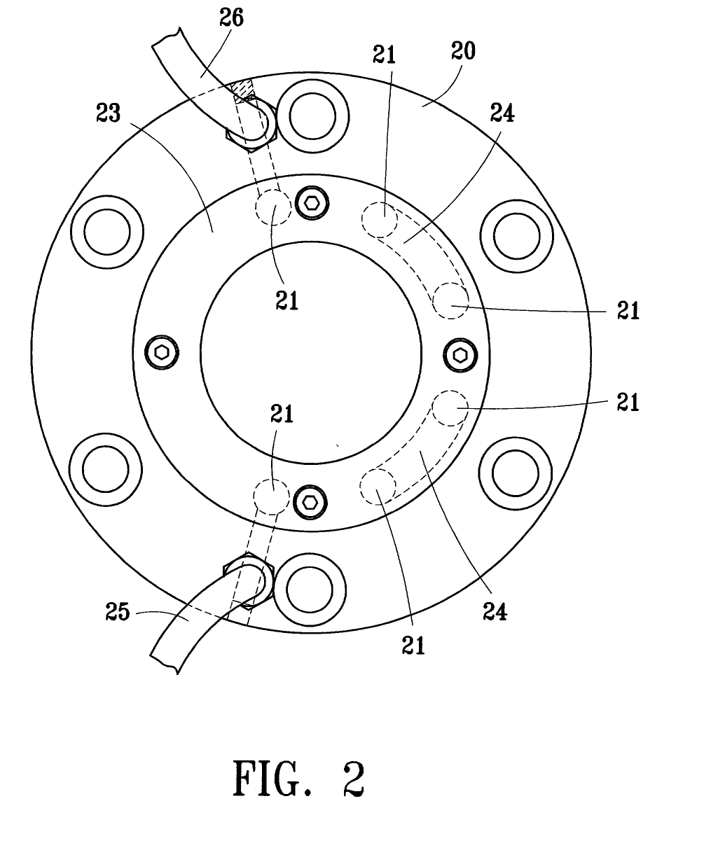

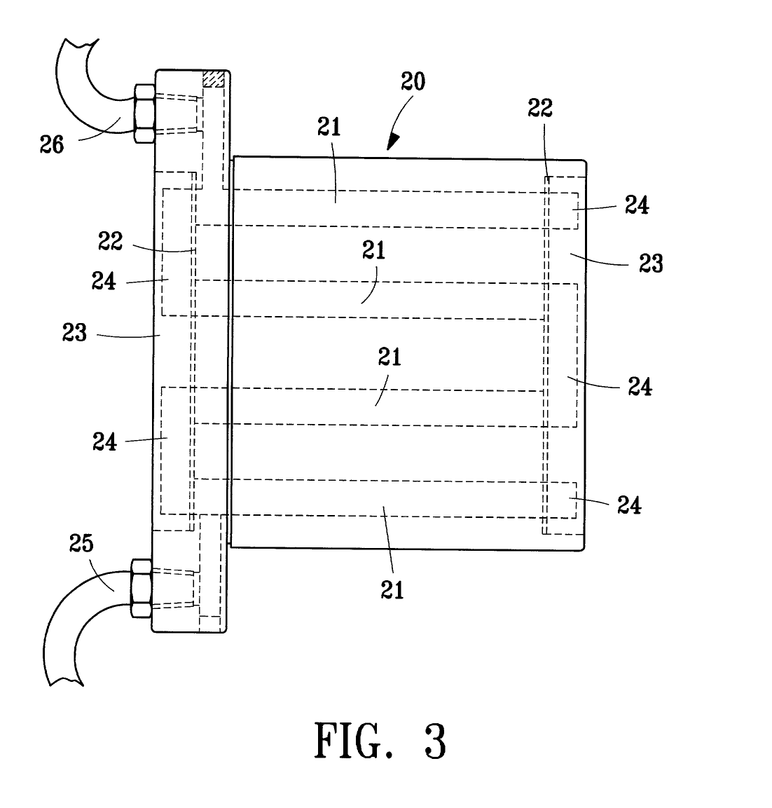

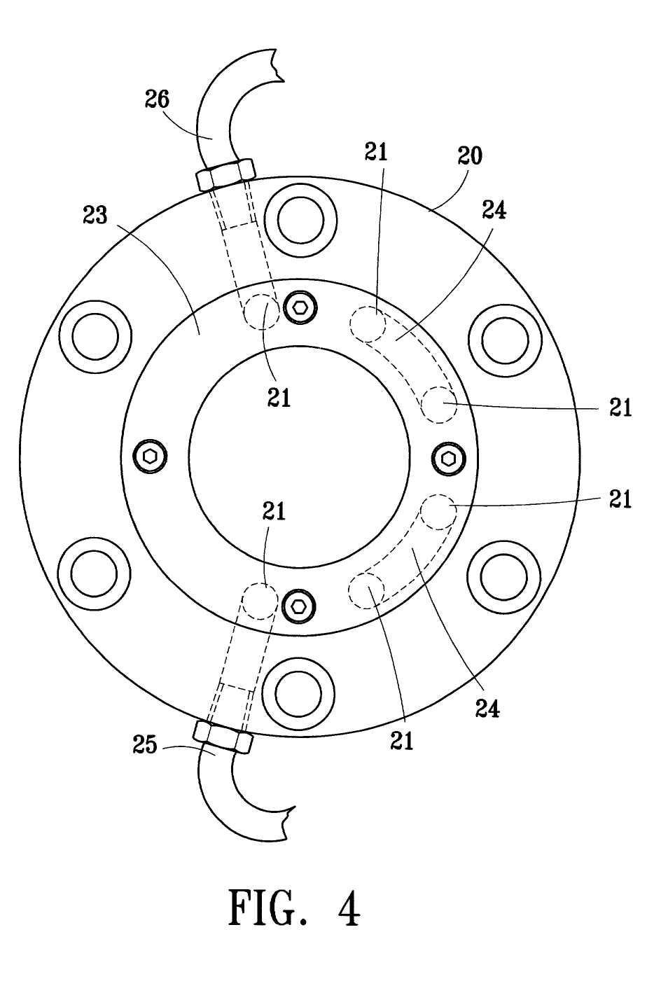

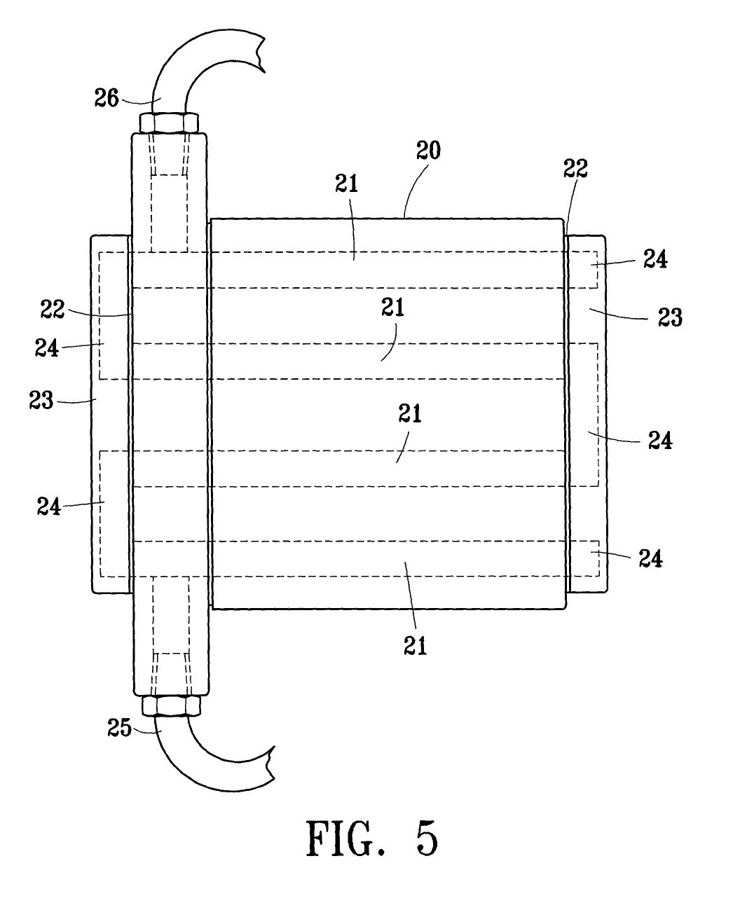

The side covers 23 and the leak-proof spacers 22 of two sides can be set inside of two sides of the nut 20, as shown in FIGS. 2 and 3. They can also be locked on the two sides of the nut 20, as shown in FIGS. 4 and 5.

The inlet 25 and the outlet 26 of the cooling medium described above respectively locate at the two open ends of the circumfluence circulating channel. They can be set on the two sides of the net 20, as shown in FIGS. 2 and 3, or set on the external circumferential face of the nut 20, as shown in FIGS. 4 and 5, or set on two sides or the external circumferential face of the side covers 23, or set at certain position according to actual requirement of assembly.

The inlet 25 and the outlet 26 can be respectively connected to a cooling medium supply device (not shown) to form a complete cooling circulatory system. The cooling medium supply device includes some known components, such as a compressor, a condenser, a expansion valve and so on, cooling down the arising temperature, which is resulted from absorbing heat of the nut 20, of the cooling medium to a lower working temperature, and then making the cooling medium circulate to enter the interior of the nut 20 to proceed heat exchange.

Comparing with the common technology, which is described above, of trenching channels at the interior of the screw, the cooling ball screw having a cooling channel provided from the present invention has following advantages:

1) Cooling directly the nut, which produces higher working temperature, and having better general cooling effect such that the ball screw is more suitable than common hallow screws for modern high-speed machine tools with high feed rate and high processing precision, ensures the precision of the ball screw and arises the life of the ball screw,

2) Forming a circumfluence circulating channel of the cooling medium inside the nut instead of the commonly seen technology of the one-way flow channel to effectively extend time of heat exchange between the cooling medium and the nut such that efficiency of heat exchange can be arisen effectively;

3) Avoiding the phenomenon of eccentric vibration produced in the commonly seen hollow screw because of the linear motion of the nut, and resulting in having no detrimental influence on processing precision and relatively arising the processing precision of machine tools;

4) That the outlet and the inlet of the cooling medium can be choose to be set directly on the nut or the side covers of the two sides of the nut, and the space required for setting is much smaller than that of the commonly seen hollow screw such that it is suitable for setting in narrow space and this is convenient and suitable for mechanism design and space arrangement of every machine which uses a ball screw as a transmission component (such as machine tools); and

5) Having easy and convenient method of assembly because the user simply uses the common connection to connect the inlet and outlet of the circumfluence circulating channel such that the cooling medium can be led into the interior of the nut for cooling.

Many changes and modifications in the above described embodiment of the invention can, of course, be carried out without departing from the scope thereof. Accordingly, to promote the progress in science and the useful arts, the invention is disclosed and is intended to limited only by the scope of the appended claims.

What is claimed is:

1. A ball screw having a cooling channel, which comprises a screw, a nut which is driven by said screw to have a linear motion along said screw, a plurality of balls set between said screw and said nut, a balls circulatory system making said balls have a circulating motion, and at least one cooling channel is set to pass through the interior of said nut such that a cooling medium can be supply into said cooling channel to cool said nut.

2. A ball screw having a cooling channel as recited in claim 1, wherein a two sides of said nut respectively has a side cover having at least one trough channel, which is connected with said cooling channel set in the interior of said nut to form a circulating channel having an inlet and an outlet.

3. A ball screw having a cooling channel as recited in claim 2, wherein a leak-proof spacer is set between said nut and said side covers of said two sides.
